(19) United States
(12) Patent Application Publication
(10) Pub. No.: US 2007/0091531 A1
(43) Pub. Date: Apr. 26, 2007

(54) Method for forming a interference fringe and method for forming a interference pattern

(76) Inventor: Jun-Hong Lin, Tainan (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/502,379

(22) Filed: Aug. 11, 2006

(30) Foreign Application Priority Data
Aug. 12, 2005 (TW) 094127619

(51) Int. Cl. H01H 73/00

(52) U.S. Cl. 361/115

(57) ABSTRACT

The present invention relates to an exposure method for forming an interference fringe and a method for forming an interference pattern on a photoresist material. The exposure method utilizes using the photoresist exposed in a first exposure procedure as a second mask in a second exposure procedure, so as to allow the light beam of the second exposure to generate interference fringes together with a physical mask. Thereby, the number of the masks is reduced, and the interference fringes can be easily controlled.

### BACKGROUND OF THE INVENTION

1. Field of the Invention

The present invention relates to a method for forming an interference pattern on a photoresist material, and more particularly to a method for forming an interference pattern on a photoresist material at the bottom by the use of an exposed photoresist serving as a second mask.

2. Description of the Related Art

In the field of exposure and development, a photoresist with an interference pattern is required to be formed on a substrate to meet particular requirements of, for example, forming a continuous changing pattern on the substrate or obtaining a small pitch.

In FIGS. 1 and 2, a conventional method for forming a photoresist with an interference pattern is shown. In the conventional method, a photoresist layer 13 is first formed on a substrate 14. Next, a first mask 11 and a second mask 12 are provided above the photoresist layer 13, wherein the first mask 11 has a first pattern 111, and the second mask 12 has a second pattern 121. Usually, the first mask 11 shifts a predetermined distance from the second mask 12, such that the first pattern 111 and the second pattern 121 are not completely overlapped.

Then, a light beam 15 is provided to perform an exposure procedure, wherein the light beam 15 generates interference fringes on the photoresist layer 13 after passing through the first pattern 111 and the second pattern 121. Finally, a development procedure is performed. If the photoresist layer 13 is a positive photoresist, the photoreceptive portion of the photoresist layer 13 is dissolved to form an interference pattern 131, as shown in FIG. 2.

The above method has disadvantages in that the procedure is complicated, and the alignment of the two masks 11, 12 is not precise, such that the interference effect is not satisfactory. Moreover, the manufacturing cost of the two masks 11, 12 is high, and thus the cost of the whole procedure is high.

Two light beams can also be used to directly form interference fringes that are then projected onto the photoresist layer 13. However, this method has the disadvantage of using a complicated and expensive optical mechanism, thus leading to a high cost for the whole procedure.

Therefore, it is necessary to provide a method for forming an interference pattern on a photoresist material that solves the above problems.

### SUMMARY OF THE INVENTION

The objective of the present invention is to provide an exposure method for forming interference fringes. The exposure method of the invention utilizes the photoresist exposed in a first exposure procedure serving as a second mask in a second exposure procedure, so as to allow the light beam of the second exposure to generate interference fringes together with a physical mask. Thereby, the number of the masks is reduced, and the interference fringes can be easily controlled.

Another objective of the present invention is to provide an exposure method for forming interference fringes, wherein the width of the formed fringe is smaller than the fringe width of the pattern of the mask, such that the fringe can be applied to a light emitting diode (LED) chip to enhance the light extraction efficiency of the chip, or applied to a microlens of an LCD to change the light shape to obtain a uniform outgoing light. Furthermore, the interference fringes formed by the present invention have a smooth and gradually varied characteristic curve, and thus can be used as an exposure pattern like a gray-scale mask.

In order to achieve the above objectives, the present invention provides an exposure method for forming interference fringes, which comprises the following steps:

(a) providing a photoresist layer, a buffer layer, and a bottom layer, wherein the buffer layer is sandwiched between the photoresist layer and the bottom layer;

(b) providing a mask, wherein the mask has a pattern;

(c) projecting a first light beam to perform an exposure procedure on the photoresist layer, so that the photoresist layer has a photoreceptive area;

(d) moving the mask; and

(e) projecting a second light beam, wherein interference fringes are formed on the bottom layer after the second light beam passes through the pattern and the photoresist.

Another objective of the present invention is to provide a method for forming an interference pattern on a photoresist material. In this method, a first photoresist layer exposed in a first exposure procedure is used as a second mask in a second exposure procedure, so as to allow the light beam of the second exposure to generate interference fringes on a second photoresist layer at the bottom together with a physical mask. Then, a development procedure is performed to form an interference pattern on the second photoresist layer. Thereby, the number of the masks is reduced, and the interference pattern can be easily controlled.

### BRIEF DESCRIPTION OF THE DRAWINGS

FIGS. 1 and 2 show a conventional method for forming a photoresist with an interference pattern;

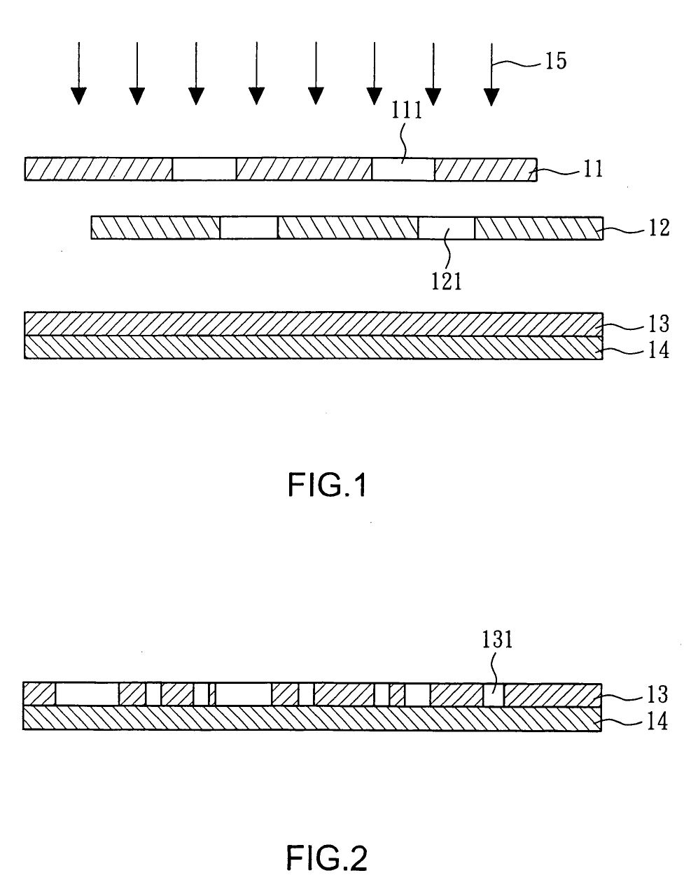

FIGS. 3 to 9 show a method for forming an interference pattern on a photoresist material according to the present invention;

FIG. 10 is a photographic view of the interference fringes formed according to the present invention; and

FIG. 11 is a photographic view after the photoresist layer formed according to the present invention etches a substrate.

### DETAILED DESCRIPTION OF THE INVENTION

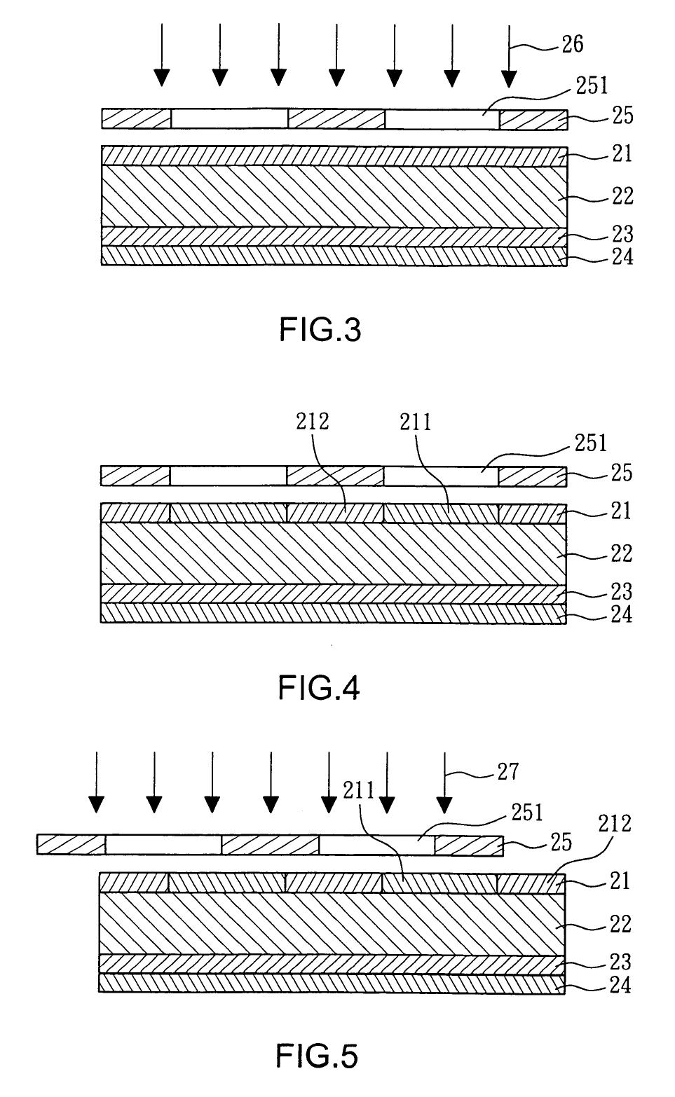

In FIGS. 3 to 9, a method for forming an interference pattern on a photoresist material according to the present invention is shown. The method of the present invention includes the following steps.

First, referring to FIG. 3, a first photoresist layer 21, a buffer layer 22, and a bottom layer (for example, a second photoresist layer 23) are provided and successively disposed on a substrate 24. Thus, the buffer layer 22 is sandwiched between the first photoresist layer 21 and the second photoresist layer 23.

Next, a mask 25 is provided, which has a pattern 251.

Then, a first light beam 26 is projected to perform a first exposure procedure on the first photoresist layer 21 through the pattern 251, so that the first photoresist layer 21 has a first photoreceptive area 211 and a first non-photoreceptive area 212, as shown in FIG. 4. The shape of the first photoreceptive area 211 corresponds to the pattern 251. As the first photoreceptive area 211 is photoreceptive by the first light beam 26, the property thereof is different from that of the first non-photoreceptive area 212.

It should be noted that in this step, the energy of the first light beam 26 is only sufficient to expose the first photoresist layer 21, i.e., the first light beam 26 does not influence the second photoresist layer 23. It should be understood that in practice, the first light beam 26 may have impact on the buffer layer 22, which is acceptable and is the function of the buffer layer 22, as long as the first light beam 26 has no impact on the second photoresist layer 23.

After that, referring to FIG. 5, the mask 25 is moved to make the pattern 251 shift a predetermined distance from the first photoreceptive area 211. In the present embodiment, the manner of moving the mask 25 involves laterally moving the whole mask 25 for a predetermined distance in a horizontal direction. However, in another application, the mask 25 can be rotated a predetermined angle, or moved up and down in a vertical direction.

Then, a second light beam 27 is projected to perform a second exposure procedure on the second photoresist layer 23. As the second light beam 27 is used to expose the second photoresist layer 23, the energy of the second light beam 27 is greater than that of the first light beam 26, such that the second light beam 27 can pass through the first photoresist layer 21 and the buffer layer 22 to reach the second photoresist layer 23.

When the second light beam 27 passes through the pattern 251 and the first photoresist layer 21, as the light transmission property of the first photoreceptive area 211 in the first photoresist layer 21 is different from that of the non-photoreceptive area 212, the first photoresist layer 21 can be used as another mask, such that interference fringes are formed on the second photoresist layer 23 after the second light beam 27 passes through. It should be understood that the interference fringes can be formed on the upper surface, interior, or lower surface of the second photoresist layer 23.

Referring to FIG. 6, the second photoresist layer 23 after being exposed by the second light beam 27 forms a second photoreceptive area 231 and a second non-photoreceptive area 232, wherein the second photoreceptive area 231 has interference fringes.

It should be noted that in the present embodiment, the first and second exposure procedures use the same mask 25, thereby reducing the number of the masks and reducing the cost. However, in another application, the mask 25 can be replaced by another mask (not shown) which is different from the mask 25 in the second exposure procedure to achieve the same interference effect together with the second photoresist layer 23.

Thereafter, referring to FIG. 7, a development procedure is performed to remove the first photoresist layer 21, the buffer layer 22, and a portion of the second photoresist layer 23. If the second photoresist layer 23 is a positive photoresist, the second photoreceptive area 231 thereof, the first photoresist layer 21, and the buffer layer 22 are dissolved together to form an interference pattern 233, as shown in FIG. 7. The interference pattern 233 corresponding to the second non-photoreceptive area 232 is a positive pattern.

Furthermore, in the development procedure, the first photoresist layer 21 and the buffer layer 22 can be first dissolved, and the second photoresist layer 23 is left and then heated, as shown in FIG. 8. Finally, the second non-photoreceptive area 232 of the second photoresist layer 23 is dissolved to form an interference pattern 234, as shown in FIG. 9. The interference pattern 234 corresponding to the second photoreceptive area 231 is a negative pattern.

In the present invention, the photoresist exposed in the first exposure procedure is used as a second mask in the second exposure procedure, so as to allow the light beam of the second exposure to generate interference fringes together with a physical mask. Thereby, the number of the masks is reduced, and the interference fringes can be easily controlled.

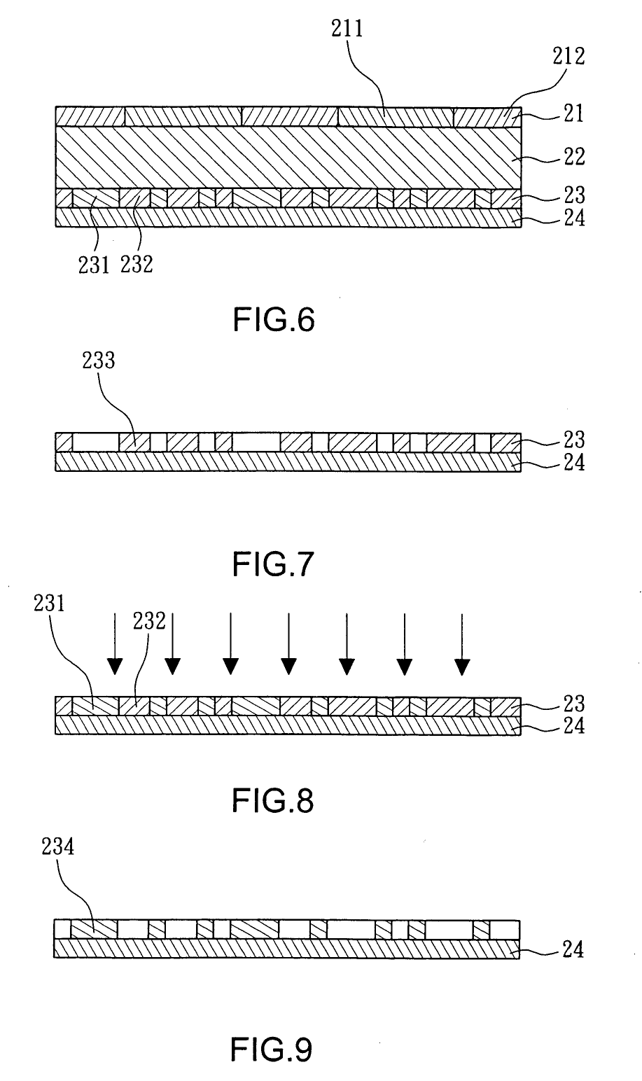

In FIG. 10, a photographic view of the interference fringes formed according to the present invention is shown. As shown in the figure, the interference fringes formed according to the present invention have a smooth and gradually varied characteristic curve, i.e., the fringe gradually varies from right to left. Thus, the interference fringes can be used as an exposure pattern like the gray-scale mask.

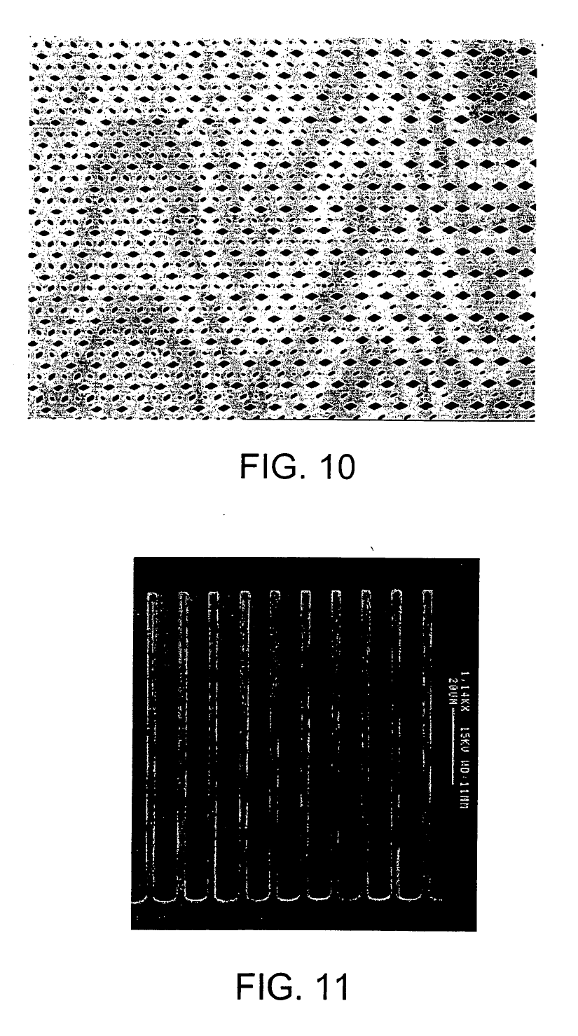

In FIG. 11, a photographic view after the photoresist layer formed by the present invention etches a substrate is shown. The etching is performed under the conditions of an aspect ratio of 18:1, a SiO₂ physical mask, and an etching rate of 2.2 m/min. As shown in FIG. 11, after the substrate is etched, the line width is about 2 μm, which is smaller than the line width of the pattern of the physical mask. Therefore, the present invention can be applied to an LED chip to enhance the light extraction efficiency of the chip, or applied to a microlens of an LCD to change the light shape to obtain a uniform outgoing light.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope as defined in the appended claims.

What is claimed is:

1. An exposure method for forming an interference fringe, comprising:
(a) providing a photoresist layer, a buffer layer, and a bottom layer, wherein the buffer layer is sandwiched between the photoresist layer and the bottom layer;
(b) providing a mask, wherein the mask has a pattern;
(c) projecting a first light beam to perform an exposure procedure on the photoresist layer, so that the photoresist layer has a photoreceptive area;
(d) moving the mask; and
(e) projecting a second light beam, wherein interference fringes are formed on the bottom layer after the second light beam passes through the pattern and the photoresist.

2. The method as claimed in claim 1, wherein the bottom layer is a second photoresist layer.

3. The method as claimed in claim 1, wherein the mask is laterally moved for a predetermined distance in a horizontal direction in the step (d).

4. The method as claimed in claim 1, wherein the mask is rotated for a predetermined angle in the step (d).

5. The method as claimed in claim 1, wherein the mask is moved up and down in a vertical direction in the step (d).

6. The method as claimed in claim 1, wherein the energy of the second light beam is greater than that of the first light beam.

7. An exposure method for forming an interference fringe, comprising:
(a) providing a photoresist layer, a buffer layer, and a bottom layer, wherein the buffer layer is sandwiched between the photoresist layer and the bottom layer;
(b) providing a first mask, wherein the mask has a first pattern;
(c) projecting a first light beam to perform an exposure procedure on the photoresist layer, so that the photoresist layer has a photoreceptive area;
(d) removing the first mask and providing a second mask, wherein the second mask has a second pattern; and
(e) projecting a second light beam, wherein interference fringes are formed on the bottom layer after the second light beam passes through the second pattern and the photoresist.

8. The method as claimed in claim 7, wherein the bottom layer is a second photoresist layer.

9. The method as claimed in claim 7, wherein the energy of the second light beam is greater than that of the first light beam.

10. A method for forming an interference pattern on a photoresist material, comprising:
(a) providing a first photoresist layer, a buffer layer, and a second photoresist layer, wherein the buffer layer is sandwiched between the first photoresist layer and the second photoresist layer;
(b) providing a mask, wherein the mask has a pattern;
(c) performing a first exposure procedure on the first photoresist layer, so that the first photoresist layer has a first photoreceptive area;
(d) moving the mask;
(e) performing a second exposure procedure on the second photoresist layer, so that the second photoresist layer has a second photoreceptive area, wherein the second photoreceptive area has interference fringes;
(f) removing the first photoresist layer and the buffer layer; and
(g) removing a portion of the second photoresist layer to form an interference pattern.

11. The method as claimed in claim 10, wherein the mask is laterally moved for a predetermined distance in a horizontal direction in the step (d).

12. The method as claimed in claim 10, wherein the mask is rotated for a predetermined angle in the step (d).

13. The method as claimed in claim 10, wherein the mask is moved up and down in a vertical direction in the step (d).

14. The method as claimed in claim 10, wherein the energy of the light beam used in the second exposure procedure is greater than that of the light beam used in the first exposure procedure.

15. A method for forming an interference pattern on a photoresist material, comprising:
(a) providing a first photoresist layer, a buffer layer, and a second photoresist layer, wherein the buffer layer is sandwiched between the first photoresist layer and the second photoresist layer;
(b) providing a first mask, wherein the first mask has a first pattern;
(c) performing a first exposure procedure on the first photoresist layer, so that the first photoresist layer has a first photoreceptive area;
(d) removing the first mask and providing a second mask, wherein the second mask has a second pattern;
(e) performing a second exposure procedure on the second photoresist layer, so that the second photoresist layer has a second photoreceptive area, wherein the second photoreceptive area has interference fringes;
(f) removing the first photoresist layer and the buffer layer; and
(g) removing a portion of the second photoresist layer to form an interference pattern.

16. The method as claimed in claim 15, wherein the energy of the light beam used in the second exposure procedure is greater than that of the light beam used in the first exposure procedure.
